(19) United States
(12) Patent Application Publication
(10) Pub. No.: US 2025/0370932 A1
(43) Pub. Date: Dec. 4, 2025

(54) DIRECT DATA TRANSFER WITH CACHE LINE OWNER ASSIGNMENT

(71) Applicant: Akeana, Inc., Santa Clara, CA (US)

(72) Inventor: Madhavi Kondapaneni, Cupertino, CA (US)

(73) Assignee: Akeana, Inc., Santa Clara, CA (US)

(21) Appl. No.: 19/221,682

(22) Filed: May 29, 2025

Related U.S. Application Data
(60) Provisional application No. 63/653,402, filed on May 30, 2024.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.

(51) Int. Cl. G06F 12/0831; G06F 12/0808; G06F 12/084

(52) U.S. Cl. CPC G06F 12/0831; G06F 12/0808; G06F 12/084

(57) ABSTRACT

Techniques for data sharing are disclosed. A system-on-a-chip (SoC) is accessed. The SoC includes one or more cache coherency blocks (CCBs) and one or more coherency ordering agents (COAs). Each COA includes a directory snoop filter (DSF). Each CCB is communicatively coupled to each COA by a network-on-a-chip (NOC) interface. A CCB requests a cache line associated with a memory address. The CCB is not a sharer of the cache line. A directory snoop filter (DSF) within a COA is read. The reading reveals one or more CCB sharers of the cache line and indicates there is no CCB owner. The COA includes a coherent last level cache (LLC) that contains a valid copy of the cache line. The COA assigns ownership of the cache line to the CCB. The assigning is recorded in the DSF. The cache line is forwarded by the coherent LLC to the CCB.

### RELATED APPLICATIONS

This application claims the benefit of U.S. provisional patent applications “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, and “Weight-Stationary Matrix Multiply Acceleration With A Prefilled Memory Hierarchy” Ser. No. 63/803,977, filed May 12, 2025.

Each of the foregoing applications is hereby incorporated by reference in its entirety.

### FIELD OF ART

This application relates generally to data sharing and more particularly to direct data transfer with cache line owner assignment.

### BACKGROUND

Processor efficiency plays an important role in the performance and overall functionality of modern products across various industries. High-speed processors can enable faster product development as they allow engineers to test multiple design variations, run simulations, and analyze results more quickly, facilitating a more rapid development cycle. In fields such as machine learning, high-performance processors significantly speed up the training process and data analysis. Moreover, efficient processors consume less power, contributing to longer battery life in portable devices and reducing energy costs in data centers. This is particularly important for mobile devices, laptops, and any product aiming for sustainability and reduced environmental impact. A related benefit of efficient processors is that they generate less heat during operation. Reduced heat generation is essential for devices where thermal management is a concern, such as for laptops, servers, and embedded systems. Lower heat generation helps maintain stable operating conditions and prevents overheating. Furthermore, efficient processors enable sleek and compact designs for various products. This is especially crucial for mobile devices, wearables, and IoT (Internet of Things) devices where size and weight considerations are important. Efficient processors contribute to cost savings in terms of both manufacturing and operational expenses. Additionally, lower power consumption reduces electricity costs, and the ability to use smaller cooling solutions can lead to cost savings in device manufacturing.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions to be executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

The development of faster computer processors significantly impacts the speed, efficiency, and capabilities of product development across various industries, leading to faster innovation, better products, and improved user experiences. As technology continues to advance, there is a growing emphasis on developing processors that strike a balance between high performance and energy efficiency to meet the diverse needs of various applications and industries.

### SUMMARY

Cache coherency is a crucial aspect of multiprocessor systems where each processor has its own cache. Cache coherency ensures that all processors in the system have a consistent view of shared memory, preventing data inconsistencies and errors. Without coherency, one processor's modifications might not be visible to other processors, leading to data inconsistencies and errors. In parallel programming, where multiple threads or processes execute concurrently, maintaining cache coherency is essential for the correctness of the program. Coherency mechanisms ensure that the order of memory operations is preserved, preventing unexpected behavior in parallel execution. Coherency ensures that processors always have up-to-date and consistent copies of shared data. Without coherency, a processor might work with stale data from its cache, leading to incorrect computations and unpredictable behavior. Thus, maintaining cache coherency is very important for proper and efficient operation of processors. Cache coherency can represent a tradeoff involving performance and complexity. Without any caching at all, the complexity of managing copies of data is reduced, but performance suffers. When multiple levels of cache are used, performance gains can be achieved, but there can be additional complexity and/or overhead to manage copies of data located in cache memory.

Techniques for data sharing are disclosed. A system-on-a-chip (SoC) is accessed. The SoC includes one or more cache coherency blocks (CCBs) and one or more coherency ordering agents (COAs). Each COA includes a directory snoop filter (DSF). Each CCB is communicatively coupled to each COA by a network-on-a-chip (NOC) interface. A CCB requests a cache line associated with a memory address. The CCB is not a sharer of the cache line. A directory snoop filter (DSF) within a COA is read. The reading reveals one or more CCB sharers of the cache line and indicates that there is no CCB owner. The COA includes a coherent last level cache (LLC) that contains a valid copy of the cache line. The COA assigns ownership of the cache line to the CCB. The assigning is recorded in the DSF. The cache line is forwarded by the coherent LLC to the CCB.

A processor-implemented method for data sharing is disclosed comprising: accessing a system-on-a-chip (SoC), wherein the SoC includes one or more cache coherency blocks (CCBs) and one or more coherency ordering agents (COAs), wherein each COA within the one or more COAs includes a directory snoop filter (DSF), and wherein each CCB within the one or more CCBs is communicatively coupled to each COA within the one or more COAs by a network-on-a-chip (NOC) interface; requesting, by a first CCB within the one or more CCBs, a cache line associated with a memory address, wherein the first CCB is not a sharer of the cache line; reading, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line; assigning, by the first COA, to the first CCB, an ownership of the cache line, wherein the assigning is recorded in the DSF; and forwarding the cache line, by the coherent LLC, to the first CCB. In embodiments, the cache line was previously evicted from a previous CCB owner. In embodiments, the NOC interface includes an M×N mesh topology, wherein the M×N mesh topology includes a coherent tile at each point of the M×N mesh topology, and wherein the first COA is located on a different coherent tile than the first CCB. In embodiments, the requesting comprises a request to own the cache line associated with the memory address. In embodiments, the forwarding includes sending, by the first COA, an invalidating snoop to the one or more CCB sharers of the cache line, wherein the one or more CCB sharers of the cache line are indicated by a presence vector within the DSF.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a direct data transfer with cache line owner assignment.

FIG. 2 is a flow diagram for forwarding a cache line in an M×N matrix.

FIG. 3 is a system block diagram of a multicore processor with a compute coherency block.

FIG. 4 is an example of an M×N mesh topology.

FIG. 5 is an example table of local snoop vectors for a 4×4 mesh topology.

FIG. 6 is an example of a snoop vector.

FIG. 7 is a block diagram of a switching unit.

FIG. 8 is a block diagram of a directory snoop filter (DSF).

FIG. 9 is a block diagram for reading a DSF in a different tile in an M×N mesh.

FIG. 10 is a block diagram for granting ownership within a DSF.

FIG. 11 is a block diagram for back invalidating sharers.

FIG. 12 is a block diagram for forwarding data in an M×N mesh.

FIG. 13 is a block diagram for updating sharers in a DSF.

FIG. 14 is a system diagram for a direct data transfer with cache line owner assignment.

### DETAILED DESCRIPTION

Processors are found in devices that play a role in nearly every aspect of daily life. The processors enable the devices within which the processors are located to execute a wide variety of applications. These electronic devices can provide wide-ranging features such as large or small, stationary or portable, and powerful or simple, or handheld, among others. Popular electronic devices include personal electronic devices such as computers, handheld electronic devices such as smartphones and tablets, and wearable electronic devices such as smartwatches. The electronic devices are also present in household devices including kitchen and cleaning appliances; vehicles, including personal, private, and mass transportation vehicles; and medical equipment; among many other familiar devices. Each of these devices is constructed with one type or often many types of integrated circuits, or chips. The chips enable required, useful, and desirable device features by performing processing and control tasks. Electronic processors enable the devices to execute a typically vast range and number of applications. The applications include data processing; entertainment; messaging; patient monitoring; telephony; vehicle access, configuration, and operation control; etc.

Additional electronic elements can be coupled to the processors in higher-function chips such as system-on-a-chip (SoC) devices. The SoCs enable feature and application execution. The additional elements typically include one or more of memories, radios, networking channels, peripherals, touchscreens, battery and power controllers, and so on. The applications include telephony, messaging, data processing, patient monitoring, vehicle access and operation control, etc. There are various types of processors, including mesh processors. Mesh processors use a mesh network to interconnect cores. In this approach, each processor core is connected to multiple neighboring cores, creating a mesh-like structure. Data travels through the shortest path to its destination, reducing latency. In particular, the mesh topology helps in reducing data transfer latency and improves overall bandwidth. With multiple pathways available for communication, data can be routed more efficiently, reducing potential bottlenecks. Furthermore, mesh processors can offer improved fault tolerance. If one pathway or core fails, data can often be rerouted through alternate paths, reducing the impact of a single point of failure. The improved fault tolerance can promote the stability and reliability of the processor. Additionally, mesh architectures are highly scalable. As updated designs include more cores, they can be integrated into the mesh network, allowing for efficient communication between the cores while creating processors that have more capabilities.

Another factor that plays a role in the performance of computing systems is cache hierarchy. An efficient cache hierarchy within a computer system can provide significant performance improvements. Caches are faster than main memory. An efficient cache hierarchy ensures that frequently accessed data is readily available in the fastest (closest to the processor) and smallest cache levels, reducing the time taken to access data and instructions. This enhances the overall system performance. By placing frequently used data closer to the processor, a good cache hierarchy helps in reducing memory access latency. This means that the processor spends less time waiting for data, which can otherwise cause significant delays in program execution. Moreover, caches can help reduce power consumption and improve energy efficiency by minimizing the need to access the larger, slower main memory. Accessing the cache often consumes less power than accessing the main memory, leading to overall energy savings in the system. Furthermore, by storing frequently accessed data closer to the processor, a good cache hierarchy minimizes the amount of data that needs to be fetched from the slower main memory. This reduces memory traffic and alleviates memory bus congestion, thus enhancing overall system efficiency.

During processor execution, the contents of portions or blocks of a shared or common memory can be moved to local cache memory. The move to local cache memory can enable a significant boost to processor performance. The local cache memory is smaller and faster, and is located closer to an element that processes data than is the shared memory. The element can include a coherent tile, where a coherent tile can include a processor, cache management elements, memory, and so on. A processor can include multiple coherent tiles arranged in a mesh (grid) topology. The local cache can be shared between coherent tiles, enabling local data exchange between the coherent tiles. The local cache can enable the sharing of data between and among coherent elements, where the elements can be located within an M×N mesh topology. Thus, in embodiments, the coherent tiles are organized in an M×N mesh topology in which a coherent tile is positioned at each point of the M×N mesh topology. The use of local cache memory is beneficial computationally because cache use takes advantage of both “locality” of instructions and data typically present in application code as the code is executed. Coupling the cache memory to hierarchical tiles drastically reduces memory access times because of the adjacency of the instructions and the data. A hierarchical tile does not need to send a request across a common bus, across a crossbar switch, through buffers, and so on to access the instructions and data in a shared memory such as a shared system memory. Similarly, the coherent tile does not experience the delays associated with the shared bus, buffers, crossbar switch, etc.

Maintaining cache coherency during operation of a processor-based system, such as an SoC that includes an M×N mesh topology, is critical for reliable operation. Cache coherency ensures that data stored in caches remains consistent with the data stored in the main memory. Without cache coherency, there is a risk of data corruption and errors in the execution of programs. Moreover, in the case of an SoC that includes an M×N mesh topology, each core may have its own multilevel cache. For proper operation, when one core modifies data, the changes must be reflected in the caches of other cores to maintain a consistent view of memory across all cores.

A cache memory can be accessed by one, some, or all of a plurality of coherent tiles within the mesh topology. The access can be accomplished without having to access the slower common memory, thereby reducing access time and increasing processing speed. When a memory access operation is requested by a coherent tile in a coherent memory architecture, the coherent tile can issue a snoop operation. The snoop operation can indicate that the initiating coherent tile intends to access a portion or block of shared memory. The snoop operation can be used to notify other coherent tiles within the mesh that the contents of the shared memory are to be read or written. A snoop operation associated with a write operation can include an invalidating snoop operation. The invalidating snoop operation can cause other coherent sharers of the cache line to invalidate that cache line in their respective caches. The invalidating of cache lines can be accomplished using cache management techniques.

An M×N mesh topology can include a coherent tile at one or more points in the mesh. Each coherent tile can include a cache coherency block (CCB) which can include a number of processors or multicore processors and a shared coherent cache. The coherent tile can also include a coherency ordering agent (COA). The COA can ensure that coherency is maintained between multiple CCBs in the Mx N mesh. The COA can use a directory snoop filter (DSF) to help perform the coherency. In embodiments, the DSF can include multiple presence vectors, where each presence vector includes a field of bits that includes an owner identifier, owner valid bit, and/or other data to indicate ownership and/or sharing of particular cache data. However, to avoid a very wide DSF, the DSF can have a different number of ways than the number CCBs in the system. If the DSF is too wide, timing and area problems can result in the physical implementation of the DSF. These problems can adversely affect reliability, power consumption, and other factors. Because the DSF has a different number of ways than the CCBs, an opportunity for a cache miss is present. The DSF is first searched for an invalid (available) cache line in the slot (way) that matches the index of the address that is associated with a current read request. However, if no available slot exists, a DSF capacity eviction is performed.

The eviction process can maintain the performance benefits that are achieved with a cache hierarchy, while eliminating the need for extra gates and timing issues that would be needed with a larger DSF. However, a situation in which a shared cache line does not have an owner can arise when a cache line is evicted. There can still be sharers of the ownerless cache line. If another CCB, that is not a current sharer, needs to modify the ownerless cache line, it needs to first become an owner. Promoting a current sharer CCB to become a temporary owner, and then transferring ownership to the requesting CCB for performing cache line modification, can be inefficient.

Disclosed embodiments address the aforementioned inefficiency by performing techniques for direct data transfer with cache line owner assignment. An ownerless cache line to be modified is identified as corresponding to data in a last level cache (LLC). The COA associated with the LLC can transfer the data in the LLC to the requesting CCB, and can grant ownership to the requesting CCB in a cohesive operation, without the need for assigning intermediate ownership. In this way, the modification of the cache line occurs in fewer clock cycles, thereby improving overall SoC performance.

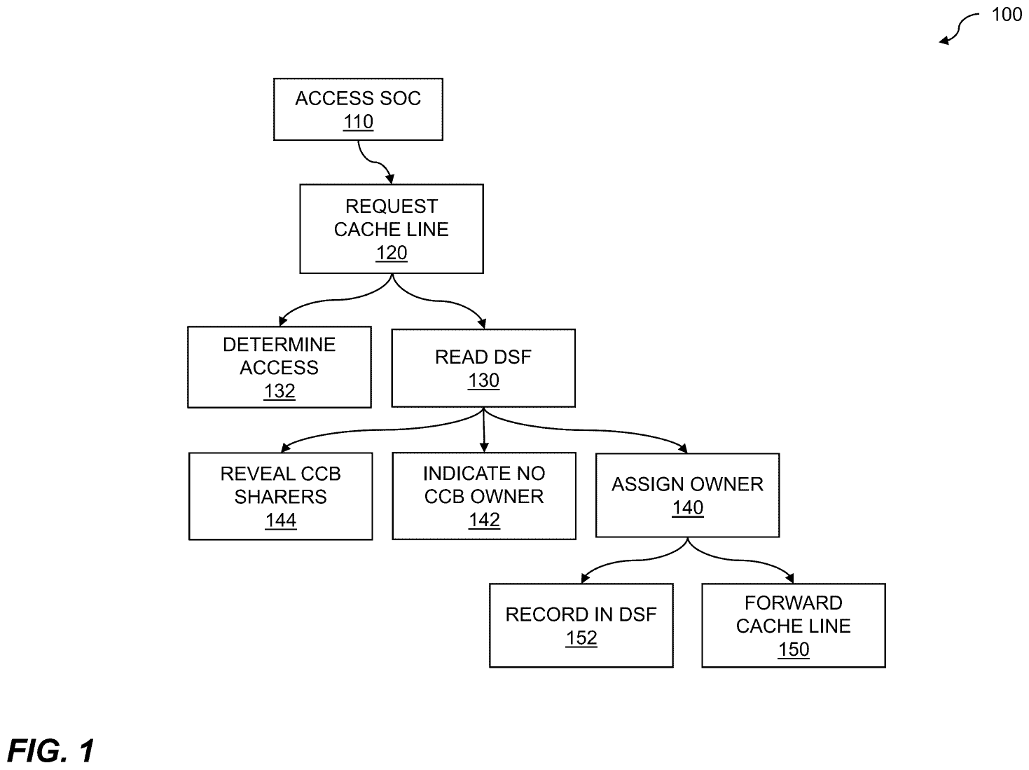

FIG. 1 is a flow diagram for a direct data transfer with cache line owner assignment. The flow 100 includes accessing an SoC 110. In one or more embodiments, the SoC can include a plurality of coherent elements, where the elements can be located within an M×N mesh topology. The elements can include multicore processors, bus interfaces, caches, switches, and the like. In embodiments, the coherent elements can support pipelined execution. The SoC can include one or more cache coherency blocks (CCBs) and one or more coherency ordering agents (COAs). Each COA within the one or more COAs can include a directory snoop filter (DSF). Each CCB within the one or more CCBs can be communicatively coupled to each COA within the one or more COAs by a network-on-a-chip (NOC) interface. In embodiments, the NOC interface includes an M×N mesh topology. The M×N mesh topology can include a coherent tile at each point of the M×N mesh topology. In embodiments, the first COA is located on a different coherent tile than the first CCB.

The flow 100 includes requesting a cache line 120. The requested cache line can be an ownerless cache line. The requested cache line can be requested for the purpose of modifying the cache line. A cache line can enter an ownerless state due to a CCB capacity eviction. In embodiments, the cache line was previously evicted from a previous CCB owner. One or more embodiments can include requesting, by a first CCB within one or more CCBs, a cache line associated with a memory address. In other embodiments, the first CCB is not a sharer of the cache line. The flow 100 includes reading a DSF entry 130. The DSF entry can include information regarding sharers and ownership. In some cases, the ownership of a cache line may be indicated as invalid, which means that the cache line does not have an owner. One or more embodiments can include reading, within a first COA, a directory snoop filter (DSF). The reading can reveal one or more CCB sharers of the cache line. In other embodiments, the reading indicates that there is no CCB owner of the cache line. In further embodiments, the first COA includes a coherent last level cache (LLC) that contains a valid copy of the cache line. In disclosed embodiments, in cases where the LLC includes a valid copy of the cache line, the cache line can be forwarded to the requesting CCB without needing to create a temporary owner. Based on reading the DSF, the flow 100 can include indicating no CCB owner 142. Thus, embodiments can include reading, within a first COA, a directory snoop filter (DSF). The reading can reveal one or more CCB sharers of the cache line. The reading can indicate that there is no CCB owner of the cache line. The first COA can include a coherent last level cache (LLC) that contains a valid copy of the cache line. Embodiments can determine that a cache line is ownerless by examining an owner valid bitfield in a corresponding entry of a DSF.

Based on reading the DSF, the flow 100 includes revealing CCB sharers 144. In one or more embodiments, the revealing of CCB sharers can be determined from a presence vector within the DSF. In one or more embodiments, the presence vector can include a field of bits (bitfield). The field of bits can include a bit per cache per core that is in the SoC. The presence vector includes an owner identifier, an owner valid bit, and/or other data to indicate ownership and/or sharing of particular cache data. In one or more embodiments, data from the DSF is used for back invalidation of cache lines prior to modification. The back invalidation can serve as a signal to sharers that the data needs to be unshared, and reacquired if still needed.

The flow 100 includes determining access 132. The determining can include identifying a COA within an M×N mesh that includes the DSF corresponding to the cache line to be modified. In embodiments, each DSF within an M×N mesh stores sharing and ownership information for a given address range. The determining can include identifying which COA includes the DSF covering the address range that includes the cache line to be modified.

The flow 100 includes assigning an owner 140. In embodiments, the owner that gets assigned can be a CCB that requests to modify the cache line while the CCB is not a current sharer of the data. Embodiments can include assigning, by the first COA to the first CCB, an ownership of the cache line. The assigning can be recorded in the DSF. The recording in the DSF can include updating one or more bitfields within the DSF, including, but not limited to, a presence vector, owner ID field, and/or owner valid field. As part of the ownership assignment, embodiments can include recording the ownership in the DSF 152. The recording of the ownership can include updating one or more bitfields in the DSF entry corresponding to the cache line. The one or more bitfields can include, but are not limited to, a presence vector, an owner ID (identifier) field, and an owner valid field. The flow 100 further includes forwarding the cache line 150. The cache line can be forwarded to the first (or requesting) CCB by the coherent LLC. In embodiments, the forwarding can be accomplished using one or more snoop vectors. In embodiments, the one or more snoop vectors can include a combination of local snoop vectors and directional snoop vectors.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

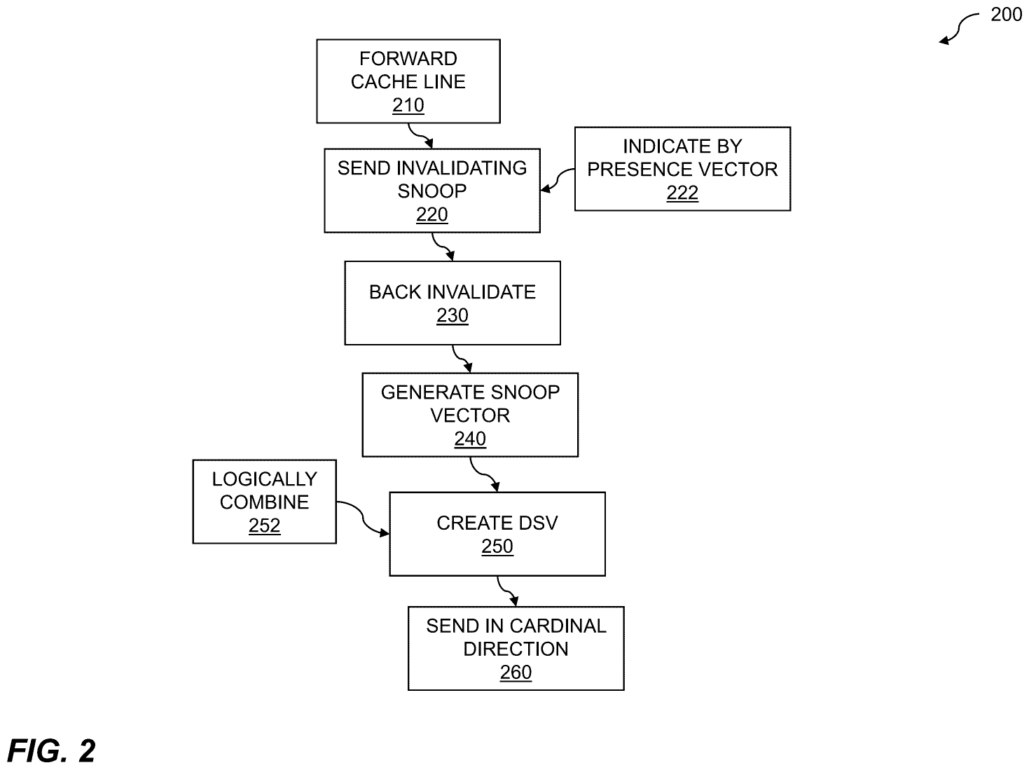

FIG. 2 is a flow diagram for forwarding a cache line in an M×N matrix. The flow 200 includes forwarding a cache line 210. The cache line can be a cache line that is requested by a CCB for modification while the CCB is not a current sharer of the cache line. The requested cache line can be valid in a last level cache (LLC) associated with a COA within the M×N matrix. In embodiments, the cache hierarchy includes three levels of cache, referred to as L1, L2, and L3. In embodiments, the L1 cache is the smallest and fastest cache, located closest to the processor cores. In embodiments, the L1 cache is divided into separate instruction and data caches and is used to store frequently accessed instructions and data. In embodiments, the L2 cache is larger than the L1 cache and is located between the L1 cache and the main memory. In embodiments, the L2 cache can be a unified cache that stores both instructions and data. The L2 cache can be slower than the L1 cache, but faster than the main memory. In embodiments, the L3 cache can be larger than the L2 cache, and can be associated with a COA of a given tile (node) within the M×N matrix. In embodiments, the last level cache (LLC) includes an L3 cache.

The flow 200 includes sending an invalidating snoop 220. In embodiments, a snoop operation associated with a write operation includes an invalidating snoop operation. Specifically, the write operation invalidates the contents of the cache by making the contents different from the contents of the shared memory. Thus, the use of smaller cache memory dictates that new cache lines must be brought into the cache memory to replace no-longer-needed cache lines (called a cache miss, which requires a cache line fill), and that existing cache lines in the cache memory that are no longer synchronized (coherent) are evicted and managed across all caches and the common memory. The evicting cache lines and filling cache lines are accomplished using cache management techniques. The flow can include indicating by presence vector 222. In one or more embodiments, a presence vector within an entry of a DSF indicates all sharers of a cache line, and thus, indicates which sharers need to be notified that the corresponding cache data is to be flushed for the purposes of maintaining cache coherency. The flow 200 further includes back invalidating 230. The back invalidating informs the other sharers specified in the presence vector of the corresponding DSF entry that their copy of the cache line is no longer valid and is to be invalidated. In embodiments, the forwarding includes sending, by the first COA, an invalidating snoop to the one or more CCB sharers of the cache line. The one or more CCB sharers of the cache line can be indicated by a presence vector within the DSF.

The flow 200 includes generating a snoop vector 240. The snoop vector indicates one or more other tiles within the M×N mesh topology to be notified of the snoop operation. The snoop vector can be based on information in the DSF which can keep track of all the owners and sharers of cache lines within an address range in the system. The one or more other tiles within the mesh topology can access a substantially similar address in storage, such as a shared storage element or system. The shared storage can include shared cache storage. The flow 200 further includes creating a directional snoop vector (DSV) 250. The DSV can include information that enables routing of information between coherent tiles. The flow 200 further includes logically combining 252 for creation of the DSV. The logical combining can include one or more logical operations, including bitwise ANDing. In one or more embodiments, a snoop vector is bitwise ANDed with a local snoop vector to create the DSV. In embodiments, each LSV is associated with a cardinal direction. In embodiments, the cardinal directions can include east, west, north, and south with respect to the M×N mesh topology. The flow 200 includes sending in a cardinal direction 260. Thus, embodiments can include creating a directional snoop vector (DSV). The creating can include logically combining the snoop vector with the local snoop vector. The creating can also include sending the DSV in a cardinal direction within the M×N mesh topology.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

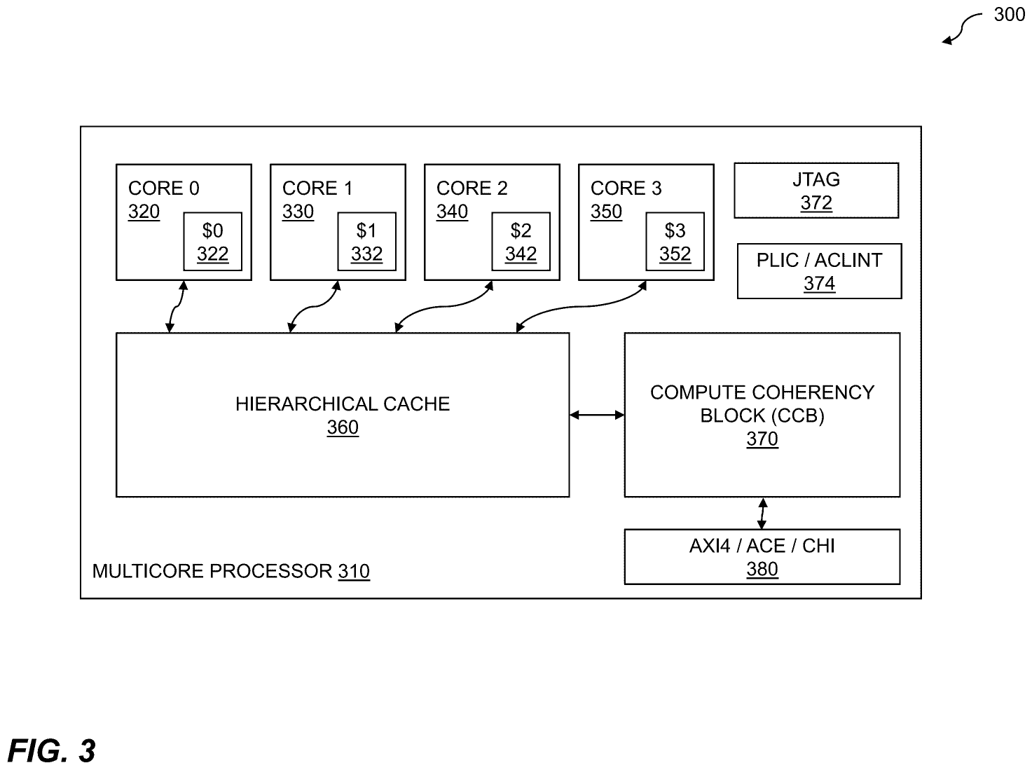

FIG. 3 is a system block diagram of a multicore processor with a compute coherency block. The system block diagram 300 shows a multicore processor 310 that includes a compute coherency block (CCB) 370. Multicore processor 310 includes core 0 320, core 1 330, core 2 340, and core 3 350. While four cores are shown in system block diagram 300, in practice, there can be more or fewer cores. As an example, disclosed embodiments can include 16, 32, or 64 cores. Each core comprises an onboard local cache, which is referred to as a level 1 (L1) cache. Core 0 320 includes local cache 322, core 1 330 includes local cache 332, core 2 340 includes local cache 342, and core 3 350 includes local cache 352.

The multicore processor 310 can further include a joint test action group (JTAG) element 372. The JTAG element 372 can be used to support diagnostics and debugging of programs and/or applications executing on the multicore processor 310 by providing access to the processor's internal registers, memory, and other resources. In embodiments, the JTAG element 372 enables functionality for step-by-step execution, setting breakpoints, examining the processor's state during program execution, and/or other relevant functions. The multicore processor 310 can further include a PLIC/ACLINT element 374. As stated previously, the PLIC (a platform level interrupt controller), and/or ACLINT (advanced core local interrupter) support features including, but not limited to, interrupt processing and timer functionalities. The multicore processor 310 can further include a hierarchical cache 360. The hierarchical cache 360 can be a level 2 (L2) cache that is shared among multiple cores within multicore processor 310. In one or more embodiments, the hierarchical cache 360 is a last level cache (LLC). The multicore processor 310 can further include one or more interface elements 380, which can include standard processor interfaces such as an Advanced extensible Interface (AXI™) including AXI4™, an ARM™ Advanced extensible Interface (AXI™) Coherence Extensions (ACE™) interface, an Advanced Microcontroller Bus Architecture (AMBA™) Coherence Hub Interface (CHI™).

The multicore processor 310 further includes a compute coherency block (CCB) 370. In one or more embodiments, the compute coherency block (CCB) 370 is responsible for maintaining coherency between one or more caches such as local caches associated with the processor cores and the shared memory system. In embodiments, the CCB 370 interfaces to the hierarchical cache 360 and the interface elements 380. The compute coherency block can perform one or more cache maintenance operations such as writing back “dirty” data in one or more caches or memory. The dirty data can result from changes to the local copies of shared memory contents in the local caches. The changes to the local copies of data can result from processing operations performed by the processor cores as the cores execute code. Similarly, data in the shared memory can be different from the data in a local cache due to an operation such as a write operation.

In the system block diagram 300, the compute coherency block (CCB) 370 can interface with a DSF. In embodiments, the snoop requests can be based on physical addresses for the shared memory structure. The CCB 370 can perform the functions associated with transferring cache ownership, and/or initiating direct cache transfers (DCTs) in accordance with disclosed embodiments. The physical addresses can include absolute, relative, offset, etc. addresses in the shared memory structure. In embodiments, the DSF can include a two-dimensional matrix, in which each column of the two-dimensional matrix can be headed by a unique physical address corresponding to a particular snoop request. The physical address can correspond to one or more read operations generated by one or more processors within the plurality of processor cores. In embodiments, an additional physical address can initialize an additional column to the two-dimensional matrix when the physical address is unique. The additional physical address can include a unique physical address within a cluster of addresses to be accessed by the plurality of processors. In other embodiments, an additional physical address can add an additional row to the two-dimensional matrix when the physical address is non-unique. The adding the row indicates that an additional read operation has been generated by a processor core. A column within the two-dimensional matrix can comprise a “snoop chain,” where the snoop chain can include a head or first snoop and a tail snoop. In embodiments, the additional row can comprise the tail of a snoop chain for each column of the two-dimensional matrix. In one or more embodiments, the CCB 370 communicates with a home node that includes a DSF to orchestrate direct cache transfers between one or more cores within a plurality of multicore processors within an SoC. In embodiments, an SoC can include coherent request nodes that include the functional blocks shown in FIG. 3. In embodiments, the first coherent request node comprises a plurality of processor cores and caches.

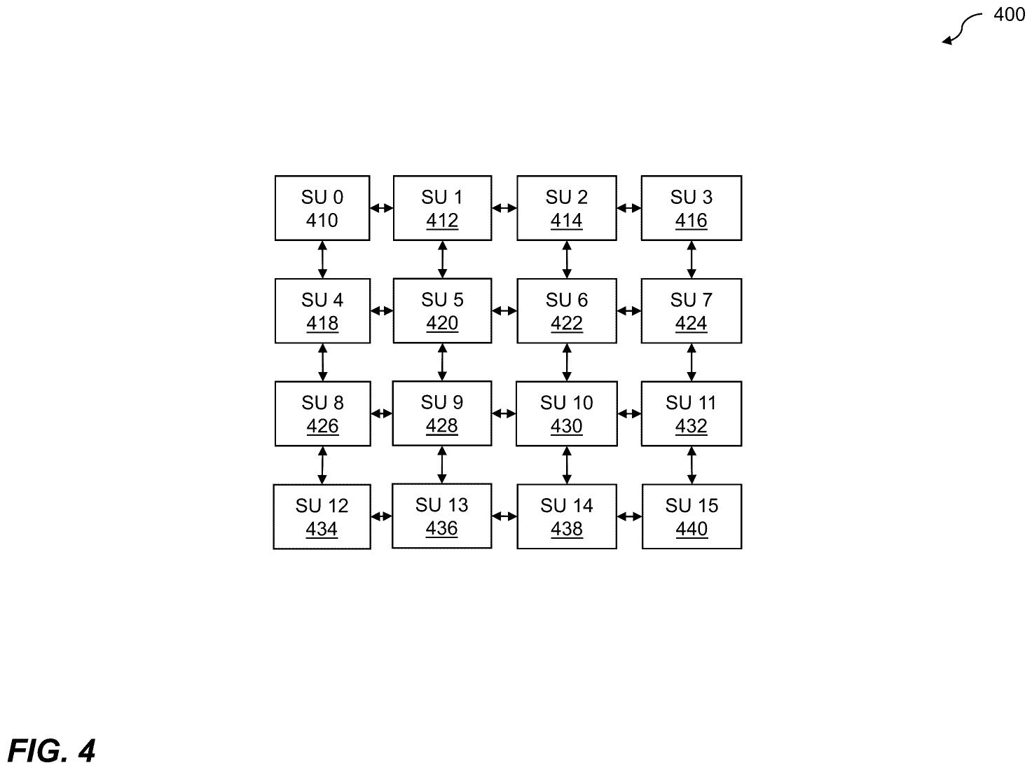

FIG. 4 is an example showing an M×N mesh topology. In the example 400, the values of M and N are both equal to 4. However, in one or more embodiments, M and/or N can be larger or smaller than 4. In one or more embodiments, M may be unequal to N. Snoop vectors such as multi-cast snoop vectors can be used to manage access to storage. The storage can include cache storage that is shared by tiles associated with a system-on-a-chip (SoC). A snoop vector can be used to alert one or more other tiles that a tile is requesting access to an address in the shared cache storage. The access request can include a read request, a write request, a read-modify-write request, and so on. The tiles can be configured within the SoC using a mesh topology. The tiles can include switching units, where the switching units can route snoop vectors to one or more tiles, within the mesh topology, that access the same shared storage address. The mesh topology can be enabled by multi-cast snoop vectors. A system-on-a-chip (SoC) is accessed, wherein the SoC includes a network-on-a-chip (NOC), wherein the NOC includes an M×N mesh topology, wherein the M×N mesh topology includes a coherent tile at each point of the M×N mesh topology, and wherein each coherent tile in the M×N mesh topology includes one or more local snoop vectors (LSVs). A snoop operation can be initiated by a first coherent tile within the M×N mesh topology. A snoop vector can be generated by the first coherent tile. The snoop vector can indicate one or more other tiles within the M×N mesh topology to be notified of the snoop operation. One or more directional snoop vectors (DSVs) can be created by the first coherent tile. The creating can include logically combining the snoop vector that was generated with each of the one or more LSVs. An adjacent coherent tile to the first coherent tile can be selected. The adjacent coherent tile can be located in a cardinal direction from the first coherent tile. In embodiments, a first DSV is chosen from the one or more DSVs. In other embodiments, the choosing is based on the cardinal direction. The snoop operation and the first DSV that was chosen can be sent by the first coherent tile to the adjacent coherent tile that was selected.

Switching units can be configured in an M×N mesh topology. The example 400 shows a 4×4 mesh. The switching units within the mesh can include switching units SU 0 410, SU 1 412, SU 2 414, SU 3 416, SU 4 418, SU 5 420, SU 6 422, SU 7 424, SU 8 426, SU 9 428, SU 10 430, SU 11 432, SU 12 434, SU 13 436, SU 14 438, and SU 15 440. In embodiments, a coherent tile can be located at any point of the M×N mesh topology. In other embodiments, a coherent tile can be located at each point of the M×N mesh topology. The coherent tile can comprise a switching unit (SU). A switching unit, which can also be referred to as a mesh switch unit, can include one or more of a memory controller interface (MCI), an input/output (I/O) mesh interface (IMI), and so on. Each switching unit can include a plurality of ports. The ports can include local ports, directional ports, and the like. The ports can be used for communication with other switching units within the mesh. Each switching unit can be in communication with nearest-neighbor SUs within the matrix. The nearest neighbor SUs within the mesh topology can be located in one or more cardinal directions. The cardinal directions can include north, south, east, and west directions. Communication with a nearest neighbor SU can be based on a cardinal direction priority. In embodiments, the cardinal direction priority can be east/west, then north/south. Noted above, the communication with nearest-neighbor SUs can be accomplished using a network-on-chip (NOC). The network-on-chip can be based on techniques including router-based packet switching.

The communication between switching units can be based on snoop vectors (see examples below in subsequent figures). The snoop vectors can include local snoop vectors (LSVs) associated with each coherent or mesh tile and directional snoop vectors (DSVs). A local snoop vector can be accessed by a first coherent tile. The local snoop vector can indicate one or more tiles within the mesh topology to be notified of a snoop operation. The snoop operation can indicate a storage address such as a storage address associated with a shared cache, shared memory, etc. The snoop operation can be associated with a read operation, a write operation, a read-modify-write operation, and so on. The first coherent tile creates one or more directional snoop vectors (DSVs). The creating the one or more DSVs can include logically combining the generated snoop vector with one or more LSVs. In embodiments, the logically combining includes a logical AND function. The communicating between switching units can be further based on selecting an adjacent switching unit or coherent tile. The adjacent SU is located in a cardinal direction in relation to the first SU. The cardinal direction can include north, south, east, or west. In embodiments, the one or more LSVs can be based on a cardinal direction priority. The cardinal direction priority can be used to select which cardinal direction can be chosen for communicating a snoop operation. In embodiments, the cardinal direction priority can be east/west, then north/south.

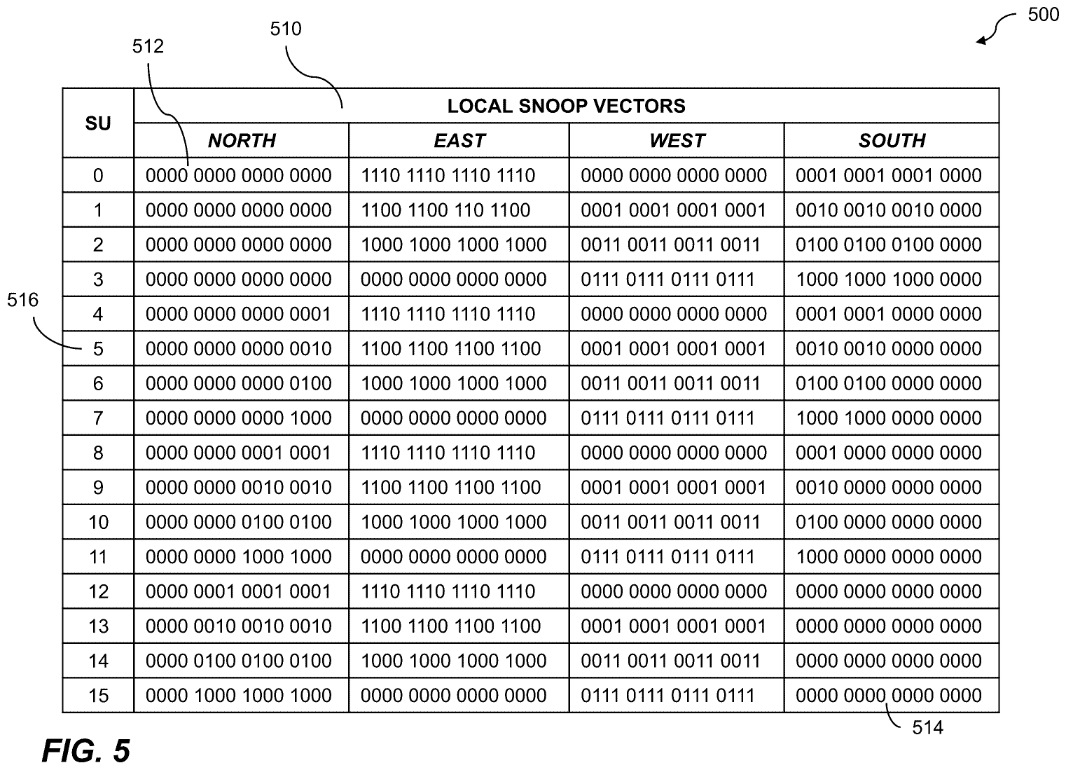

FIG. 5 shows an example of local snoop vectors for a 4×4 mesh. A first coherent tile, such as a switching unit (SU) within a mesh of SUs, can initiate a snoop operation. A snoop operation can be shared with other SUs to indicate that the first SU requires access to a location, address, region, etc. of memory. The access can be based on a memory access operation such as a memory load or store operation. The memory can include shared local cache, a shared memory system, and so on. The snoop operation and a directional snoop vector (DSV) can be used to notify other SUs of the request for memory access by the first SU by sharing the snoop vector and the DSV with an adjacent SU. The adjacent SU can be located in a cardinal direction such as to the east, west, north, and south of the SU that initiated the snoop operation. The DSV can be created by logically combining the snoop vector with one or more local snoop vectors. The local snoop vectors can indicate which other SUs can be notified by the first SU. The local snoop vectors can eliminate sending the snoop vector back to the SU that initiated the snoop operation. One or more local snoop vectors support multi-cast snoop vectors within a mesh topology. A system-on-a-chip (SoC) is accessed. The SoC can include a network-on-a-chip (NOC). The NOC can include an M×N mesh topology. The M×N mesh topology can include a coherent tile at each point of the Mx N mesh topology. Each coherent tile in the M×N mesh topology can include one or more local snoop vectors (LSVs). In embodiments, a first coherent tile within the M×N mesh topology initiates a snoop operation. A snoop vector is generated by a first coherent tile. In further embodiments, the snoop vector indicates one or more other tiles within the M×N mesh topology to be notified of the snoop operation. In embodiments, one or more directional snoop vectors (DSVs) are created by the first coherent tile. In other embodiments, the creating includes logically combining the snoop vector that was generated with each of the one or more LSVs. In further embodiments, an adjacent coherent tile to the first coherent tile is chosen. In embodiments, the adjacent coherent tile is located in a cardinal direction from the first coherent tile. In other embodiments, the snoop operation and the first DSV that were chosen are sent by the first coherent tile to the adjacent coherent tile that was selected.

In the example 500, local snoop vectors 510 are shown. The snoop vectors can be associated with tiles such as switching units within a mesh. Directional snoop vectors or DSVs can be created by a first coherent tile. The first coherent tile can include a tile within the M×N mesh of tiles. The directional snoop vectors can indicate which SUs within the mesh can be contacted from a given SU. The DSVs vary depending on a cardinal direction in which a snoop vector can be sent. The DSVs are created by logically combining the snoop vector with each of one or more local snoop vectors (LSVs). The LSVs each contain a number of bits, where the number of bits corresponds to the number of SUs within the M×N mesh. For example, for an M×N mesh comprising 4×4 SUs, the number of bits in each LSV equals 16 bits. A bit in an LSV can be set to 1 if the SU corresponding to that bit position can be “reached” by the first SU. If an SU cannot be reached or does not exist, then the LSV bit can be set to 0. In a first usage example, consider the north LSV 512 associated with an SU 0, such as SU 0 410 of FIG. 4. Since SU 0 is in the “top” row of the mesh, there are no SUs available to the north of SU 0 410. Therefore, all of the bits associated with the north LSV 512 of SU 0 are equal to 0. In a second usage example, a south LSV 514, associated with SU 15 440 of FIG. 4, also has all its bits set to 0, because there are no SUs located to the “south” of SU 15 440.

Consider the nontrivial example 516 of the local snoop vectors associated with a SU 5 such as SU 5 420 of FIG. 4. Four local snoop vectors can be associated with SU 5, one each for east, west, north, and south cardinal directions. In embodiments, the cardinal direction priority can be east/west, then north/south. As a result of the cardinal direction priority, some SUs can be accessed or notified by first sending vectors east or west before sending vectors north or south. The north local snoop vector associated with SU 5 includes a 1 in the position corresponding to SU 1 (412 of FIG. 4) while all other positions include zeros. This pattern occurs because communication with other SUs in the first row is accomplished by first sending to the east or west. The east and west local snoop vectors include ones in bit positions associated with two columns to the east and one column to the west, respectively. The SUs in the mesh columns to the east are accessed by first sending to the east once or twice, then sending to the north or the south. The mesh column to the west of SU 5 is accessed by first sending vectors to the west. The south local snoop vector associated with SU 5 includes ones in positions associated with SU 9 and SU 13 (436 of FIG. 4). These are the only two SUs to the south of SU 5 within the M×N mesh that can be notified without first sending to the east or to the west.

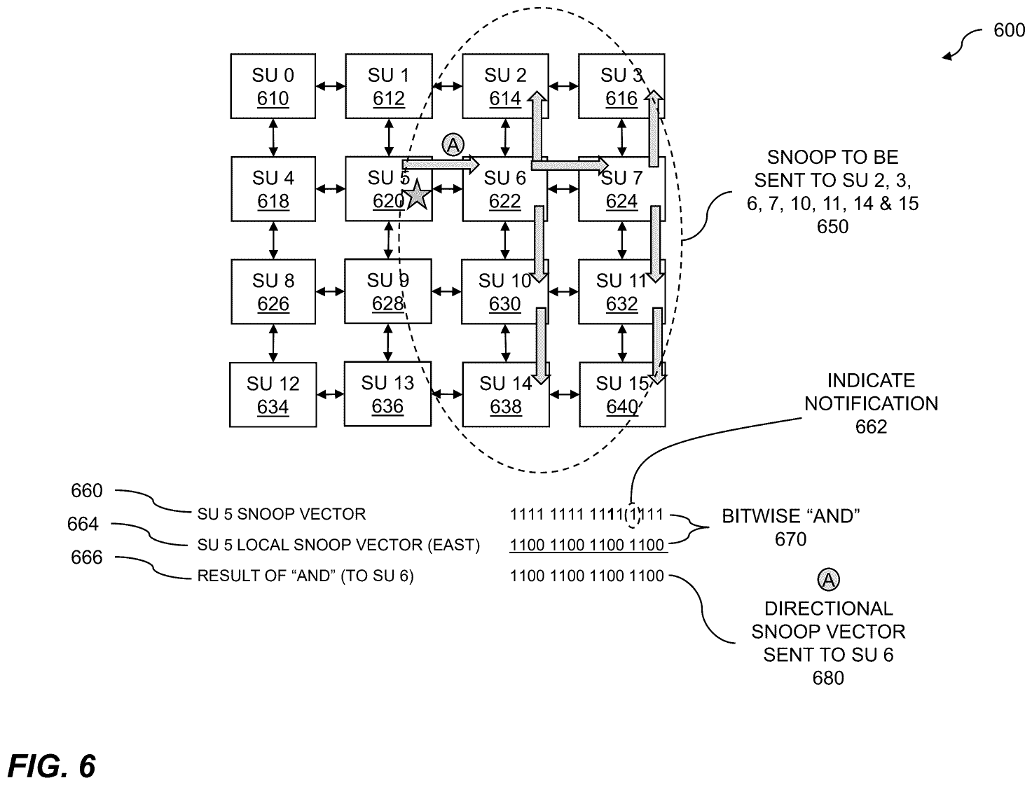

FIG. 6 is an example of a snoop vector. The example 600 includes sending a snoop to the east. A snoop operation and a chosen directional snoop vector (DSV) can be sent by a first coherent tile or switching unit (SU) to an adjacent SU. The adjacent SU can be located in a cardinal direction from the first SU. The DSV can be selected based on a cardinal direction priority. In embodiments, the cardinal direction priority can be east/west, then north/south. The adjacent SU can send the snoop vector and an additional DSV to further SUs. The SUs can be located in cardinal directions from the SU adjacent to the first SU. Based on the cardinal direction priority, the first SU can notify other SUs within an M×N array of SU. The notification can be based on a memory access request such as a load or store request from the first SU. The sending a snoop to the east supports multi-cast snoop vectors within a mesh topology. A system-on-a-chip (SoC) can be accessed. The SoC can include a network-on-a-chip (NOC). The NOC can include an M×N mesh topology. The M×N mesh topology can include a coherent tile at each point of the M×N mesh topology. Each coherent tile in the M×N mesh topology can include one or more local snoop vectors (LSVs). A first coherent tile within the M×N mesh topology can initiate a snoop operation. A snoop vector can be generated by a first coherent tile. The snoop vector can indicate one or more other tiles within the M×N mesh topology to be notified of the snoop operation. One or more directional snoop vectors (DSVs) can be created by the first coherent tile. The creating can include logically combining the snoop vector that was generated with each of the one or more LSVs. An adjacent coherent tile to the first coherent tile can be chosen. The adjacent coherent tile can be located in a cardinal direction from the first coherent tile. The snoop operation and the first DSV that were chosen can be sent by the first coherent tile to the adjacent coherent tile that was selected.

The snoop can be initiated by a coherent tile within an M×N mesh. The coherent tile can include a switching unit (SU). The M×N mesh can include a 4×4 mesh. The 4×4 mesh can include SUs SU 0 610, SU 1 612, SU 2 614, SU 3 616, SU 4 618, SU 5 620, SU 6 622, SU 7 624, SU 8 626, SU 9 628, SU 10 630, SU 11 632, SU 12 634, SU 13 636, SU 14 638, and SU 15 640. The M×N mesh can include other numbers of SUs. In the example, a snoop operation can be initiated by a first coherent tile or switching unit such as SU 5 620. Based on cardinal direction priority, such as east/west, then north/south, the snoop vector can be sent to the east. A snoop vector can be used to notify one or more SUs in the mesh of a snoop operation, such SUs 650, which include SU 2, SU 3, SU 6, SU 7, SU 10, SU 11, SU 14, and SU 15. A snoop vector 660 can be accessed by the first coherent tile. The snoop vector can include a number of bits equal to the number of coherent tiles in the M×N array. In embodiments, the bits can control a flow of sent snoop operations and directional snoop vectors. Flow control bits can include “flits.” In the example shown, the snoop vector can include 16 bits, one bit for each of the coherent tiles in the 4×4 array. The snoop vector can include a 1 to indicate that an SU should be notified of a snoop operation, or a 0 to indicate that notification of the corresponding SU is not necessary. Note that the bit position for SU 5, the initiating SU, is set to 1 as shown at 662. The one in the SU 5 position can indicate that the local cache coherency block (CCB) associated with SU 5 can receive a notification.

Continuing the example, one or more directional snoop vectors (DSVs) can be created. The DSVs can be created by logically ANDing the snoop vector with one or more local snoop vectors (LSVs). The ANDing can include a bit-wise logical AND 670. Since the snoop vector 660 will be sent to the east, SU 5 local snoop vector (east) 664 can be selected for the logical combining. The local snoop vector includes 1's in the position for the SUs that can be reached by sending east. The result of the ANDing of the SU 5 snoop vector and the SU 5 local snoop vector (east) is shown 666. The resulting vector comprises a directional snoop vector (DSV) 680. In embodiments, the snoop operation and the DSV are sent by the first coherent tile, SU 5, to the adjacent coherent tile, SU 6. From SU 6, additional directional snoop vectors can be created to notify other SUs east of SU 5. In embodiments, the sending the invalidating snoop is based on a local snoop vector. In further embodiments, the local snoop vector enables communication between coherent tiles in the M×N mesh topology.

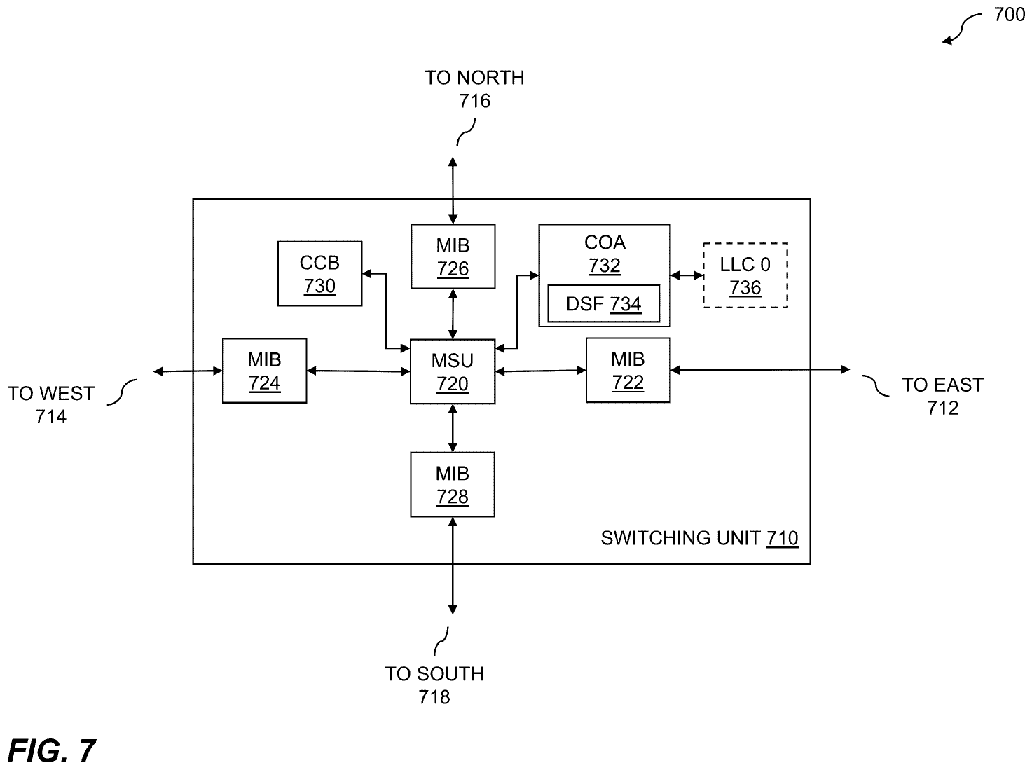

FIG. 7 is a block diagram of a switching unit (SU). In embodiments, a plurality of switching units can be configured in an M×N topology. The switching units can include one or more of a memory controller interface, an I/O mesh interface, and so on. A SU or tile can further include elements for managing coherency across the M×N topology. The various elements of a switching unit support multi-cast snoop vectors within a mesh topology. A system-on-a-chip (SoC) can be accessed. The SoC can include a network-on-a-chip (NOC). The NOC can include an M×N mesh topology. The M×N mesh topology can include a coherent tile at each point of the M×N mesh topology. A snoop operation can be initiated by a first coherent tile within the M×N mesh topology. A snoop vector can be generated by the first coherent tile. The snoop vector can indicate one or more other tiles within the M×N mesh topology to be notified of the snoop operation. One or more targeted multi-cast snoop vectors and/or coarse multi-cast snoop vectors can be created by the first coherent tile based on information in a DSF, and can be used for sending snoop operation data to one or more other coherent tiles.

As mentioned above and throughout, a mesh topology can include M×N elements in a mesh, grid, fabric, or other suitable topology. The M×N elements, which can be referred to generically as tiles associated with the mesh topology, can include elements based on a variety of configurations that perform a variety of operations, and so on. The tiles have been described as switching units (SUs), where the switching units can communicate with their nearest neighbor SUs that are located in cardinal directions from each SU. A given SU can be configured to perform one or more operations. Each SU can include one or more elements. An SU can be configured as a coherent mesh unit (CMU), a memory controller interface (MCI), an I/O control interface (ICI), and so on. The SU can be configured to enable coherency management. In the block diagram 700, a switching unit (SU) 710 can communicate with nearest neighbor SUs that are located in cardinal directions from the SU 710. The nearest neighbor communications can include cardinal directions to the east 712, to the west 714, to the north 716, and to the south 718. Recall that the cardinal directions can be prioritized. In embodiments, the cardinal direction priority can be east/west, then north/south.

The switching unit 710 can include a mesh switching unit (MSU) 720. The MSU may also be referred to as a mesh interface unit (MIU). In embodiments, the MSU can initiate a snoop operation. The snoop operation can be associated with a memory access operation such as a read (load), write (store), read-modify-write, and so on. In embodiments, the switching unit can generate a snoop vector. The snoop vector can be based on information in the DSF 734 which can keep track of all the owners and sharers of cache lines within an address range in the system. The snoop vector can include one or more other tiles within the M×N mesh topology to be notified of the snoop operation. The one or more other tiles within the mesh topology can access a substantially similar address in storage, such as a shared storage element or system. The shared storage can include shared cache storage. The MSU can communicate with other MSUs associated with further switching units using one or more interfaces. The switching unit 710 can include one or more mesh interface blocks (MIBs). The MIBs can enable communication between the SU 710 and other SUs within the mesh. The other SUs can be located in cardinal directions from the SU 710. The SU shown can include four MIBs such as MIB 722, MIB 724, MIB 726, and MIB 728. MIB 722 enables communication to the east, MIB 724 enables communication to the west, MIB 726 enables communication to the north, and MIB 728 enables communication to the south.

In embodiments, the switching unit 710 comprises a coherent tile. The coherent tile can accomplish coherency within a block, such as a cache coherency block. The cache coherency block can include processors such as processor cores, local cache memory, shared cache memory, intermediate memories, and so on. In embodiments, the first coherent tile includes a cache coherency block (CCB) such as CCB 730 and a coherency ordering agent (COA) such as a COA 732. The CCB can include a “block” of storage, where the block can include one or more of shared local cache, shared intermediate cache, and so on. The CCB can maintain coherency among cores such as processor cores, tiles, switching units, etc. The COA can be used to control coherency with other elements outside of the M×N mesh. The CCB and the COA can be included in one or more coherent tiles of switching units within the M×N mesh. In embodiments, the adjacent coherent tile can include a CCB and a COA. The adjacent block CCB and COA can be used to maintain memory coherency within the adjacent coherent tile. In embodiments, the adjacent coherent tile can include one or more memory control interfaces (MCIs).

The COA can be used to order cache accesses based on an address to be accessed. The address can include a target address associated with a memory load operation or a memory store operation. The COA can include a directory-based snoop filter (DSF) such as DSF 734. The DSF can be used to determine the current owner of a block of memory within the system. The DSF 734 can also determine the sharers of a block of memory within the system. The DSF can store information pertaining to a specific address range. The block of memory can include a cache line, a block of cache lines, and so on. In embodiments, the DSF can include an M-way associative set of tables that includes an index number, a valid bit, a presence vector, an owner ID field, an owner valid field, and so on. The COA can be used to determine which cache to access. The cache can include a last level cache, such as last level cache (LLC) 0 736. In some embodiments, only some of the COAs within an M×N matrix include an LLC. The LLC can be accessible by two or more of the switching units within the M×N mesh, a plurality of M×N meshes, and so on. The LLC can include a cache between the M×N mesh and a shared memory such as a shared system memory.

The cache coherency can be based on snoop requests and snoop responses. The snoop requests and the snoop responses can be communicated among the tiles of the M×N mesh using various communication techniques appropriate to accessing a system-on-a-chip (SoC). The communication techniques can be based on one or more subnetworks associated with the Mx N mesh. In embodiments, the subnetworks can include a request subnetwork (REQ). The REQ can receive requests for memory access from one or more cache coherency blocks (CCBs), and can send the requests to one or more coherency ordering agents (COAs). The REQ can further receive requests from one or more COAs and can send the requests to one or more memory I/O devices. The memory I/O devices can be associated with memories such as shared local, intermediate, and last level caches; a shared memory system; and the like. In embodiments, the subnetworks can include a snoop subnetwork (SNP). The snoop subnetwork can be used to send snoop requests to cache control blocks associated with one or more tiles within the M×N mesh.

In embodiments, the subnetworks can include a completion response network (CRSP). A completion response can be associated with completion of a memory access operation. The completion response can be received from a memory such as a shared cache memory, shared system memory, and so on. The completion response can be sent to one or more cache ordering agents associated with one or more tiles within the M×N mesh. In embodiments, the subnetworks can include a snoop response subnetwork. A snoop response can include a response to a snoop initiated by a coherent tile (e.g., a switching unit) within the M×N array. A snoop response can include a snoop response status. A snoop response received from a memory can be sent to one or more coherency ordering agents. The snoop response subnetwork can also receive a completion acknowledgment from one or more cache coherency blocks. The completion acknowledgment, such as a CompletionAck, can be sent to one or more coherency ordering agents.

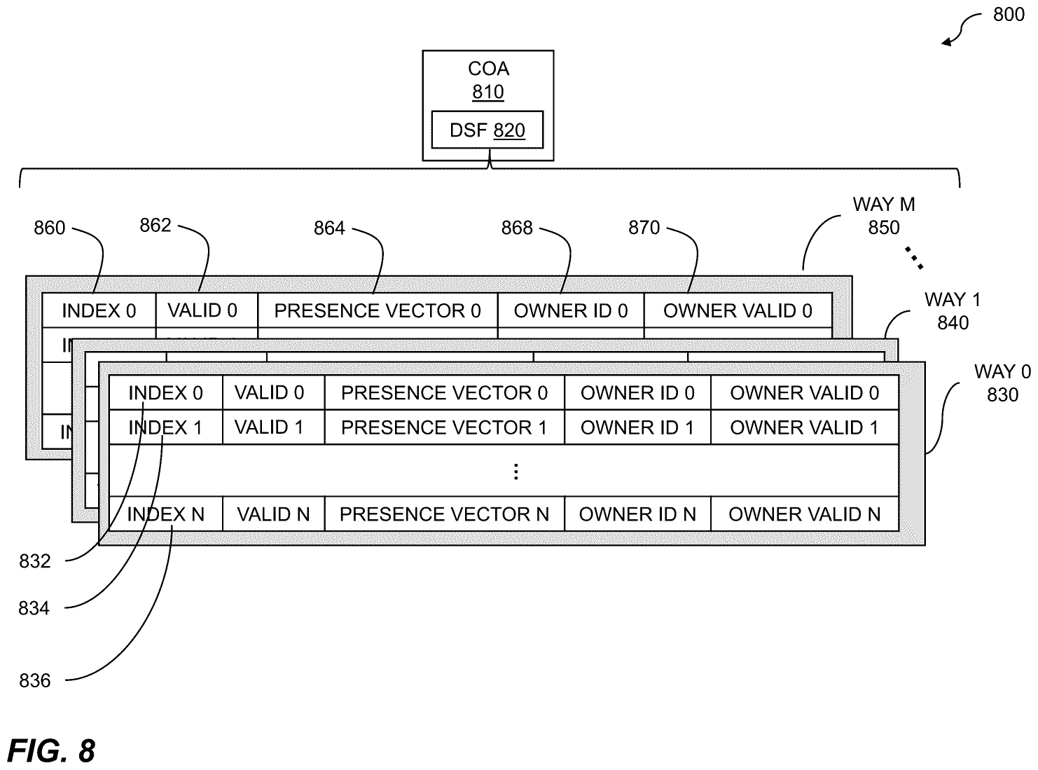

FIG. 8 is a block diagram for a directory-based snoop filter (DSF). The block diagram 800 shows a coherency ordering agent (COA) 810 that includes a DSF 820. The DSF 820 can include an M-way associative table that contains M entries. As depicted in FIG. 8, there is shown way 0 830, way 1 840, and way M 850. In one or more embodiments, the value of M can be in the range from 2-64. Other values of M are possible in disclosed embodiments. Each way includes a plurality of columns. Column 860 includes an index value. The index value provides a mechanism for identifying a given row within the DSF 820. Column 862 includes a valid indicator for a given row within the DSF 820. In one or more embodiments, when the valid indicator indicates an invalid entry, the corresponding row is deemed to be available for writing a new entry. Column 864 includes a presence vector. A presence vector can include data for sharers of one or more coherent cache lines. In one or more embodiments, the presence vector can include a field of bits. The field of bits can include a bit per cache per core that is in the SoC as previously stated. Column 868 includes an owner identifier (ID). The owner ID can include a unique number corresponding to a core within a multicore processor and/or SoC. In one or more embodiments, the owner ID can be a bit field of 8 bits, 16 bits, or some other suitable length. Column 870 includes an owner valid bit. The owner valid bit can be an indication of whether a given core owns a cache line. Ownership of a cache line can allow certain privileges such as writing to a cache line. For certain operations, such as reading from a cache line, ownership may not be required. Disclosed embodiments may modify the owner ID field, and/or owner valid bit as part of transferring ownership of a cache line from one core to another core. As shown in way 0 830, there are multiple rows, and thus multiple index values, indicated as 832, 834, and 836. In one or more embodiments, to search within the DSF, disclosed embodiments utilize an index value to reference a desired entry in the DSF. In embodiments, the DSF includes owner and sharer information for each cache line within a hierarchical cache coupled to the first CCB. In embodiments, the N ways in the DSF are not equal to a number of ways in a last level cache (LLC) within the first CCB. In embodiments, the DSF includes sharing and owner information for each shared cache line within a hierarchical coherent cache coupled to each CCB in the one or more CCBs.

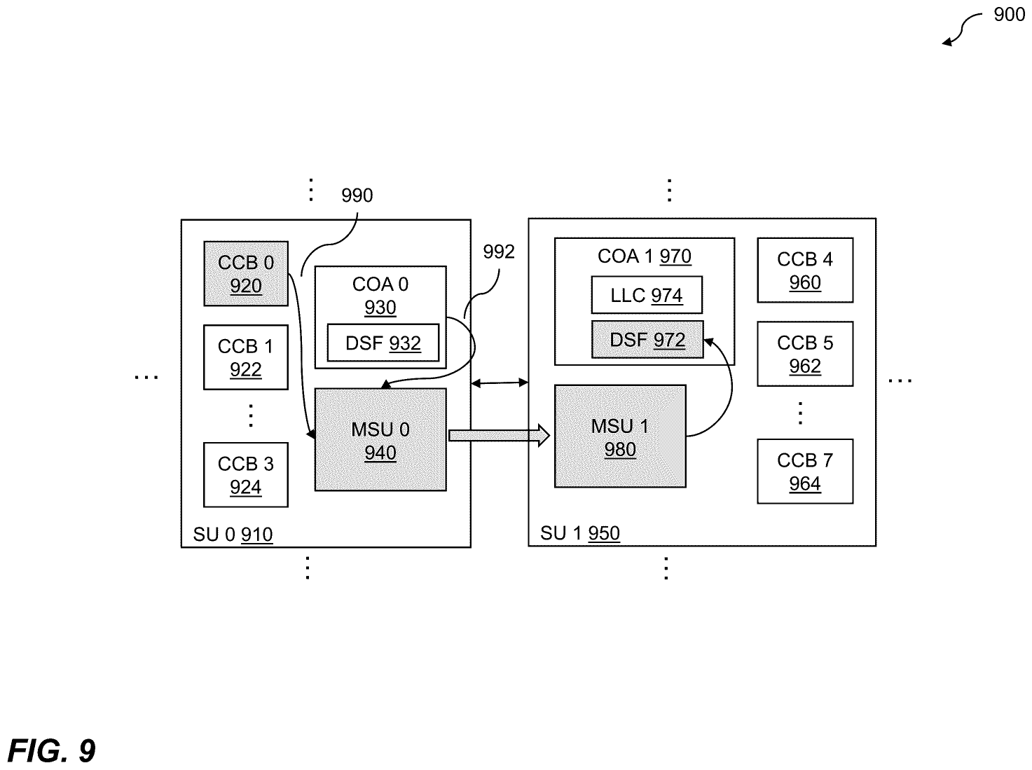

FIG. 9 is a block diagram for reading a DSF in a different tile in an M×N mesh. The block diagram 900 shows a first switching unit SU 1 950, which includes COA 1 970. COA 1 970 includes DSF 972 and LLC 974. SU 1 950 further includes multiple CCBs, indicated as CCB 4 960, CCB 5 962, and CCB 7 964. While three CCBs are shown within SU 1 950, embodiments may have more or fewer CCBs within an SU. SU 1 950 further includes mesh switching unit MSU 1 980, which serves as a communication interface for inter-tile communication within an M×N mesh. A second switching unit, SU 0 910 is adjacent to SU 1 950, from a mesh topology perspective. SU 0 910 includes COA 0 930 which includes DSF 932. Additionally, SU 0 910 includes multiple CCBs, indicated as CCB 0 920, CCB 1 922, and CCB 3 924.

In embodiments, CCB 0 920 can request to modify a cache line that is in the address range included by DSF 972 within SU 1 950. The CCB 0 920 makes a modify request, via internal routing 990, which can include one or more buses, and/or data lines within SU 0 910, to MSU 0 940, which determines that the DSF 972 needs to be accessed to determine sharer and owner information. The MSU 0 940 communicates to SU 1 950 via MSU 1 980. The MSU 1 980 relays the request to COA 1 970. The COA 1 970 determines, via access to an entry within DSF 972, that the requested cache line is currently ownerless. Moreover, the COA 1 970 determines that the LLC 974 includes a valid copy of the requested cache line. Accordingly, the COA 1 970 can initiate a direct data transfer 992 with cache line ownership under these conditions. In embodiments, the first COA manages coherency between the one or more CCBs and other coherent caches within the SoC. In embodiments, the first CCB manages coherency between one or more processor cores on a multicore processor.

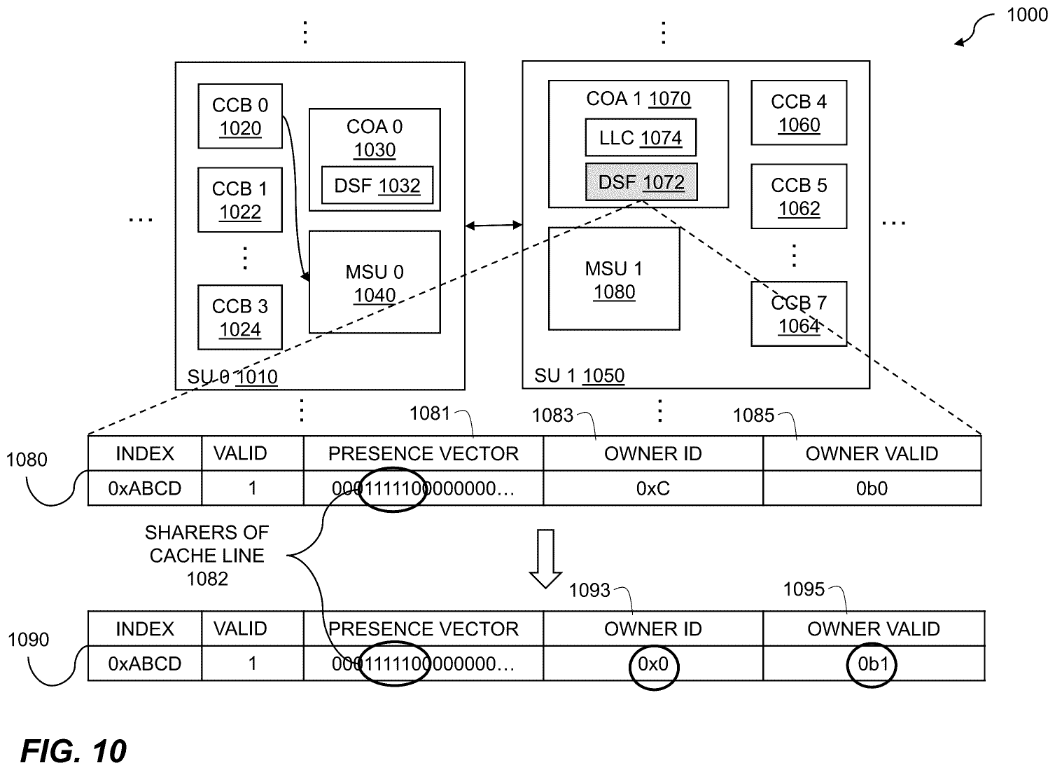

FIG. 10 is a block diagram for granting ownership within a DSF. The block diagram 1000 shows components similar to those shown in FIG. 9, along with additional details of a DSF entry. Switching unit SU 1 1050 includes COA 1 1070. COA 1 1070 includes DSF 1072 and LLC 1074. SU 1 1050 further includes multiple CCBs, indicated as CCB 4 1060, CCB 5 1062, and CCB 7 1064. While three CCBs are shown within SU 1 1050, embodiments may have more or fewer CCBs within an SU. SU 1 1050 further includes mesh switching unit MSU 1 1080, which serves as a communication interface for inter-tile communication within an M×N mesh. A second switching unit, SU 0 1010 is adjacent to SU 1 1050, from a mesh topology perspective. SU 0 1010 includes COA 0 1030 which includes DSF 1032. SU 0 1010 further includes mesh switching unit MSU 0 1040, which serves as a communication interface for inter-tile communication within an M×N mesh. Additionally, SU 0 1010 includes multiple CCBs, indicated as CCB 0 1020, CCB 1 1022, and CCB 3 1024. In embodiments, elements in FIG. 10 may be similar to corresponding elements in FIG. 9. For example, COA 1 1070 of FIG. 10 may be similar to COA 1 970 of FIG. 9, and so on.

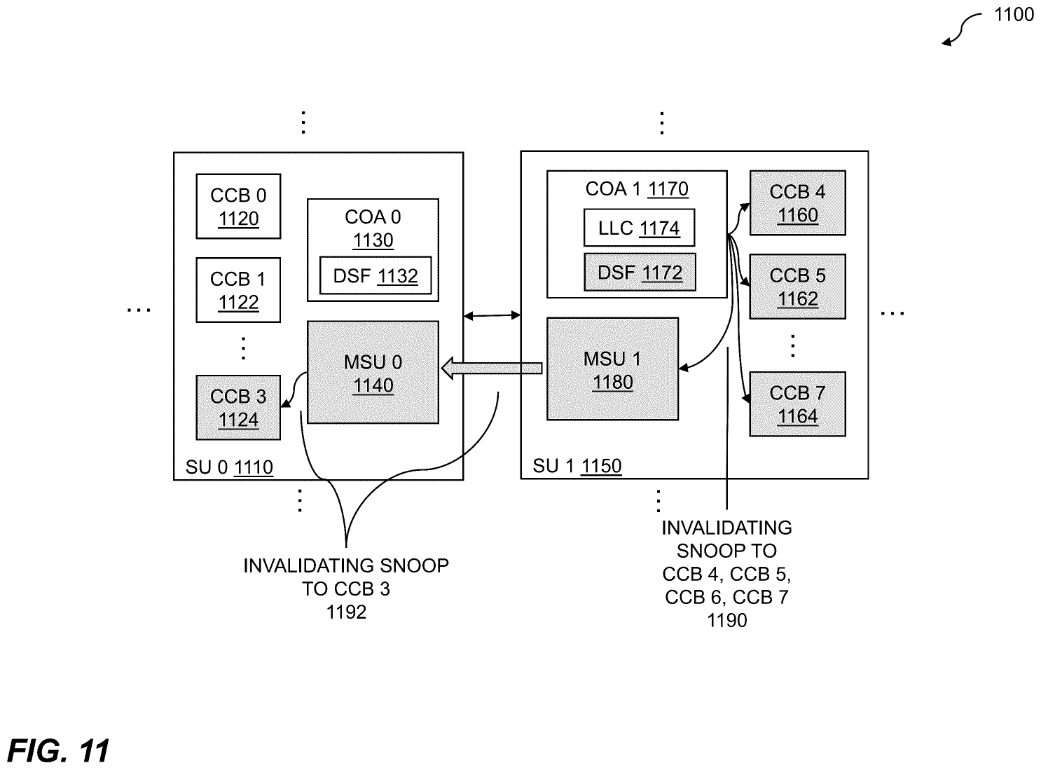

Continuing with the example from FIG. 9 and shown in FIG. 10, CCB 0 1020 is requesting to modify a cache line managed by COA 1 1070. For processing this request, COA 1 1070 inspects the corresponding entry in DSF 1072, which is shown in a beginning state at 1080. The presence vector 1081 indicates current sharers of the cache line 1082. The owner ID field 1083 indicates an owner ID of 0xC. However, the owner valid field 1085 indicates a value of 0, which indicates that there is no valid owner. Thus, the owner ID of 0xC is not valid and the COA 1 1070 identifies the cache line as ownerless. The COA 1 1070 further determines that LLC 1174 (shown on FIG. 11 and discussed subsequently) includes a valid copy of the requested cache line. In embodiments, this determination can be made via a cache controller and/or memory management unit within the COA 1 1070. The COA 1 1070 then modifies the DSF entry to an intermediate state as indicated at 1090. As shown in the intermediate state at 1090, the owner ID field 1093 is updated to reflect an owner ID of 0, and the owner valid field 1095 is updated to a value of 1, indicating that the ownership of the cache line is now transferred to CCB 0 1020, which corresponds to the owner ID of 0. The next part of the process can include back invalidating the sharers specified in the presence vector 1081.

FIG. 11 is a block diagram for back invalidating sharers. The block diagram 1100 shows components similar to those shown in FIG. 9. Switching unit SU 1 1150 includes COA 1 1170. COA 1 1170 includes DSF 1172 and LLC 1174. SU 1 1150 further includes multiple CCBs, indicated as CCB 4 1160, CCB 5 1162, and CCB 7 1164. While three CCBs are shown within SU 1 1050, embodiments may have more or fewer CCBs within an SU. SU 1 1150 further includes mesh switching unit MSU 1 1180, which serves as a communication interface for inter-tile communication within an M×N mesh. A second switching unit, SU 0 1110 is adjacent to SU 1 1150, from a mesh topology perspective. SU 0 1110 includes COA 0 1130 which includes DSF 1132. Additionally, SU 0 1110 includes multiple CCBs, indicated as CCB 0 1120, CCB 1 1122, and CCB 3 1124. In embodiments, elements in FIG. 11 may be similar to corresponding elements in FIG. 9. For example, COA 1 1170 of FIG. 11 may be similar to COA 1 970 of FIG. 9, and so on.

Continuing with the example from FIG. 9 and continued in FIG. 10, back invalidation is performed to notify all CCBs specified in the presence vectors that the data held in the cache line is no longer valid. Referring again to FIG. 10, at 1081 the presence vector is shown as including values 0001111100000000. Starting with the leftmost bit as bit 0, bits 3-7 are asserted (set to a value of “1”). Based on the asserted bits in the presence vector, CCB 4 1160, CCB 5 1162, and CCB 7 1164 receive a back invalidation of COA 1 1170 as indicated at 1190. Moreover, bit 3 refers to a CCB on another SU, which in this example, is SU 0 1110. Accordingly, the COA 1 1170 sends a back invalidation, via MSU 1 1080, to MSU 0 1140 on another coherent tile, and the MSU 0 1140 provides the back invalidation to CCB 3 1124, as indicated at 1192. The communication of the back invalidation can be based on local snoop vectors. The communication of the back invalidation can include one or more directional snoop vectors. Now that the sharers are notified of the contents of the cache line changing ownership, and are therefore potentially being modified, the next part of the process can include performing the data transfer. Embodiments include back invalidating, by each CCB sharer within the one or more CCB sharers, a local cache line within a coherent cache which contains a copy of the data associated with the memory address. Embodiments can further include generating a snoop vector, wherein the snoop vector includes the one or more CCB sharers of the cache line.

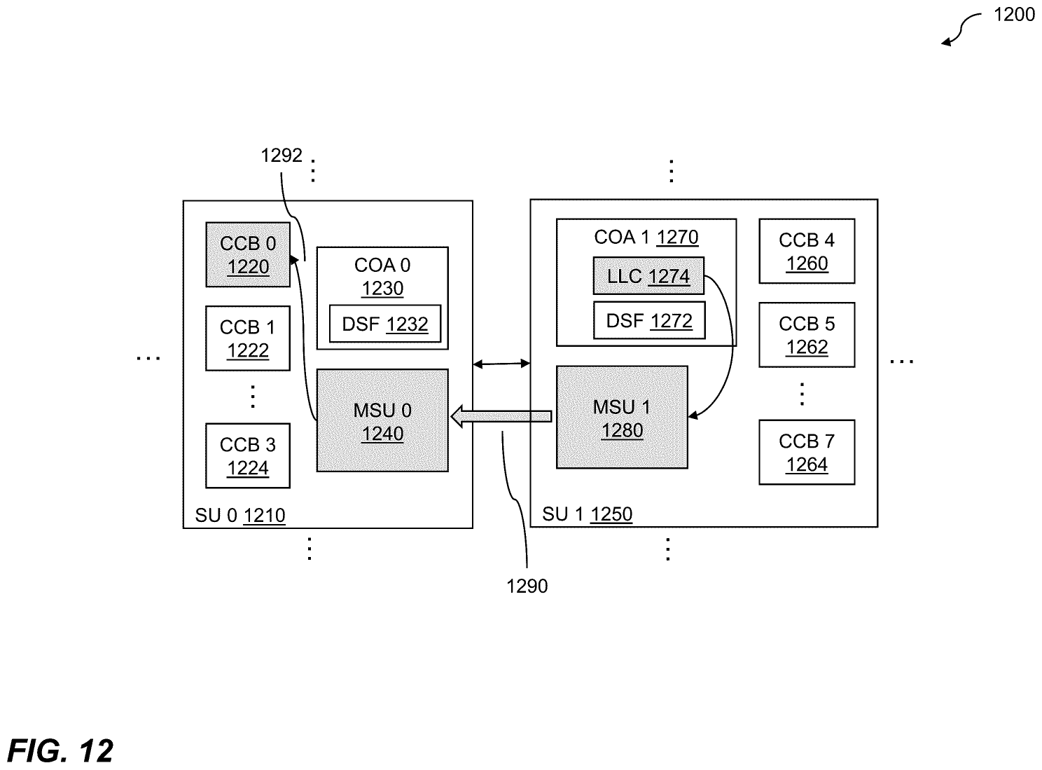

FIG. 12 is a block diagram for forwarding data in an M×N mesh. The block diagram 1200 shows components similar to those shown in FIG. 9. Switching unit SU 1 1250 includes COA 1 1270. COA 1 1270 includes DSF 1272 and LLC 1274. SU 1 1250 further includes multiple CCBs, indicated as CCB 4 1260, CCB 5 1262, and CCB 7 1264. While three CCBs are shown within SU 1 1250, embodiments may have more or fewer CCBs within an SU. SU 1 1250 further includes mesh switching unit MSU 1 1280, which serves as a communication interface for inter-tile communication within an M×N mesh. A second switching unit, SU 0 1210 is adjacent to SU 1 1250, from a mesh topology perspective. SU 0 1210 includes COA 0 1230 which includes DSF 1232. Additionally, SU 0 1210 includes multiple CCBs, indicated as CCB 0 1220, CCB 1 1222, and CCB 3, 1224. In embodiments, elements in FIG. 12 may be similar to corresponding elements in FIG. 9. For example, COA 1 1270 of FIG. 12 may be similar to COA 1 970 of FIG. 9, and so on.

Continuing with the examples from FIGS. 9-11, and shown in FIG. 12, the COA 1 1270 provides the data in LLC 1274 to MSU 1 1280, which in turn provides the cache line data 1290 to MSU 0 1240 of SU 0 1210. The MSU 0 1240 then routes the cache data to CCB 0 1220 via internal routing 1292, which can include one or more buses, and/or data lines within SU 0 1210. Now that the requesting CCB 0 is the cache line owner and has possession of the cache line data, the next part of the process can include updating sharers in the presence vector of a DSF.

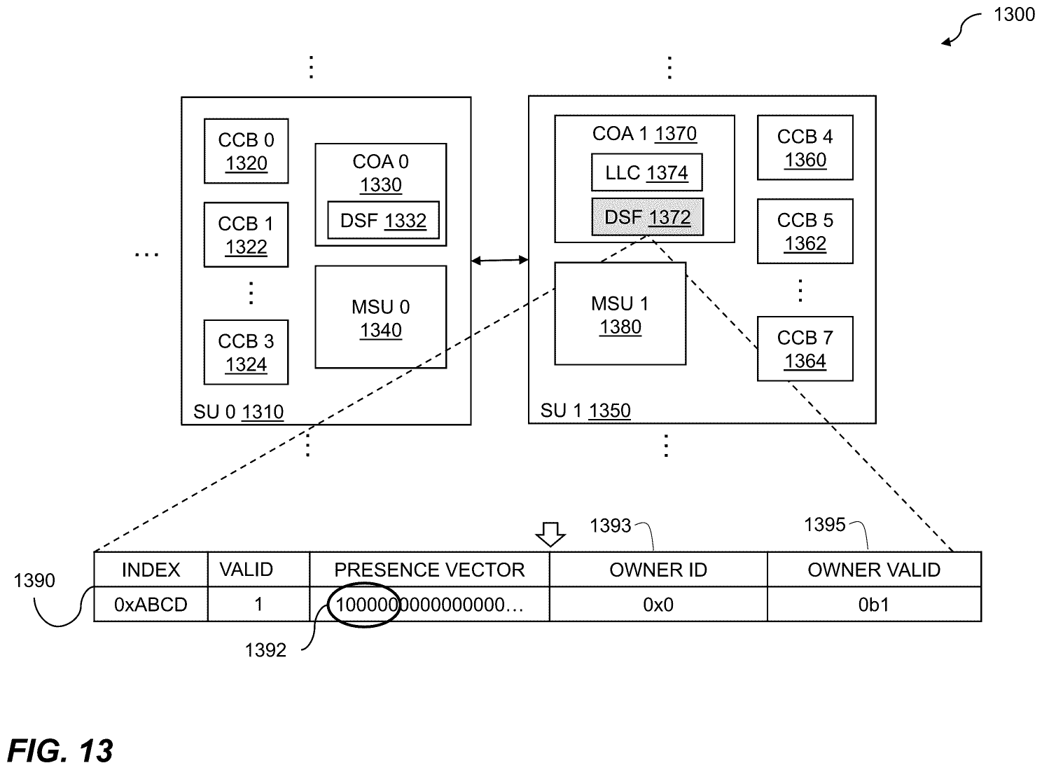

FIG. 13 is a block diagram for updating sharers in a DSF. The block diagram 1300 shows components similar to those shown in FIG. 9. Switching unit SU 1 1350 includes COA 1 1370. COA 1 1370 includes DSF 1372 and LLC 1374. SU 1 1350 further includes multiple CCBs, indicated as CCB 4 1360, CCB 5 1362, and CCB 7 1364. While three CCBs are shown within SU 1 1350, embodiments may have more or fewer CCBs within an SU. SU 1 1350 further includes mesh switching unit MSU 1 1380, which serves as a communication interface for inter-tile communication within an M×N mesh. A second switching unit, SU 0 1310 is adjacent to SU 1 1350, from a mesh topology perspective. SU 0 1310 includes COA 0 1330 which includes DSF 1332. SU 0 1310 further includes mesh switching unit MSU 0 1340, which serves as a communication interface for inter-tile communication within an M×N mesh. Additionally, SU 0 1310 includes multiple CCBs, indicated as CCB 0 1320, CCB 1 1322, and CCB 3 1324. In embodiments, elements in FIG. 13 may be similar to corresponding elements in FIG. 9. For example, COA 1 1370 of FIG. 13 may be similar to COA 1 970 of FIG. 9, and so on.

Continuing with the example from FIGS. 9-12 and shown in FIG. 13, the DSF 1372 within COA 1 1370 now updates the DSF entry 1390 corresponding to the cache line. In particular, the DSF entry 1390 includes updated presence vector 1392 which shows only the leftmost bit (bit 0) as having a value of 1 (asserted), while all other bits have a value of 0. Based on the asserted bit 0 in the updated presence vector 1392, the only sharer is CCB 0 1320, and all other CCBs are not currently sharing the cache line. The owner ID in field 1393 and owner valid field 1395 reflect that CCB 0 1320 is the current owner. From this point, CCB 0 can now safely modify the cache line while still maintaining cache coherency within the M×N mesh.

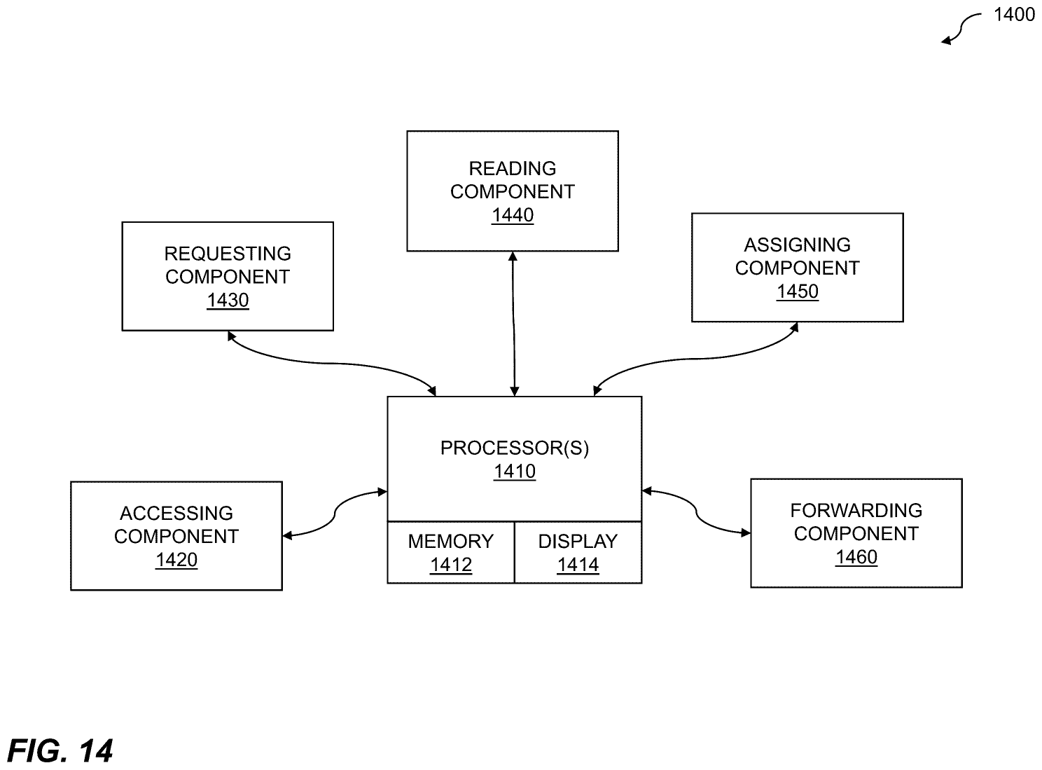

FIG. 14 is a system diagram for a direct data transfer with a cache line owner assignment. The system 1400 can comprise a processor-implemented system for instruction execution. The computer system can be based on semiconductor logic. The system can include one or more of processors, memories, cache memories, queues, displays, and so on. The processors can include standalone processors within integrated circuits or chips, processor cores in FPGAs or ASICs, two or more processor cores within a multiprocessor, and so on. The one or more processors 1410 are coupled to a memory 1412 which stores instructions, operations, snoop vectors, local snoop vectors, directional snoop vectors, and so on. The memory can include one or more of local memory, shared cache memory, shared hierarchical cache memory, system memory such as shared system memory, etc. The system 1400 can further include a display 1414 coupled to the one or more processors 1410. The display 1414 can be used for displaying data, instructions, operations, memory queue contents, various types of vectors, and the like. The operations can include snoop operations and snoop operation responses. The operations can further include cache maintenance operations, Advanced extensible Interface (AXI™) Coherence Extensions (ACE™) cache transactions, Advanced Microcontroller Bus Architecture (AMBA™) Coherence Hub Interface (CHI™) transactions, etc.

The system 1400 can include an accessing component 1420. The accessing component 1420 can include functions and instructions to enable accessing a system-on-a-chip (SoC). An SoC can include a variety of elements associated with a computing system such as one or more processor cores, input/output interfaces, local memory, memory interfaces, secondary memory interfaces, and so on. The SoC can further include elements such as radio frequency (RF) components, graphics processors, network-on-a-chip (NOC) connectivity, etc. The SoC can be based on one or more chips, FPGAs, ASICs, etc. In embodiments, the processor cores associated with the SoC can include RISC-V™ processor cores. Memory such as local memory within the SoCs includes a local cache. The local cache can include a shared local cache. The shared local cache can be colocated with other elements associated with the SoC, can be accessible by a processor core within the SoC, and so on. The processor cores can implement special cache coherency operations. The cache coherency operations can include maintenance operations such as cache maintenance operations (CMOs). The cache coherency operations can include a cache line zeroing operation, a cache line cleaning operation, a cache line flushing operation, a cache line invalidating operation, and so on.

A plurality of processor cores and coupled local caches within an SoC can include a coherency domain. The coherency can include coherency between the common memory and cache memory, such as level 1 (L1) cache memory, L2 cache memory, L3 cache memory, and so on. With a multilevel cache hierarchy, there is a last level cache (LLC) that may store one or more cache lines. The coherency between the common memory and one or more cache memories can be accomplished using cache maintenance operations (CMOs). In embodiments, a CCB can request ownership of a cache line for which the CCB is not a current sharer, and for which the cache line is currently in an unowned state.

The system 1400 can include a requesting component 1430. The requesting component 1430 can include functions and instructions for requesting, by a first CCB within the one or more CCBs, a cache line associated with a memory address, wherein the first CCB is not a sharer of the cache line. The requesting a CCB can be on the same tile (switching unit) as an LLC that is holding a valid copy of the cache line. The requesting CCB can be on a different tile (switching unit) than the tile containing the LLC that is holding a valid copy of the cache line. In one or more embodiments, a DSF corresponding to the cache line is examined to determine sharing and/or ownership status for the cache line. In embodiments, the requesting includes determining, by the first CCB, to access the first COA, wherein the determining is based on the memory address.

The system 1400 can include a reading component 1440. The reading component 1440 can include functions and instructions for reading, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line. In disclosed embodiments, during the condition of a CCB requesting an unowned cache line that the requesting CCB currently is not a sharer for, a direct data transfer with cache line owner assignment is performed, thereby providing improvements in overall performance of an SoC that comprises an M×N mesh of coherent tiles. In embodiments, the requesting comprises a request to own the cache line associated with the memory address.

The system 1400 can include an assigning component 1450. The assigning component 1450 can include functions and instructions for assigning, by the first COA to the first CCB, an ownership of the cache line, wherein the assigning is recorded in the DSF. The assigning can include asserting a bit in a presence vector of the DSF entry corresponding to the cache line. Once the first CCB has ownership of the cache line, it can perform operations that require ownership, such as writing and/or modifying the cache line. The system 1400 can include a forwarding component 1460. The forwarding component can use data from local snoop vectors, directional snoop vectors, and/or other data, for routing information between coherent tiles of an M×N mesh. The forwarding component 1460 can include functions and instructions for forwarding the cache line, by the coherent LLC, to the first CCB. The forwarding can include intra-tile communication, in which case the data in the coherent LLC is transferred to another tile (switching unit) within the M×N mesh.

The system 1400 can include a computer program product embodied in a non-transitory computer readable medium for sharing data, the computer program product comprising code which causes one or more processors to generate semiconductor logic for: accessing a system-on-a-chip (SoC), wherein the SoC includes one or more cache coherency blocks (CCBs) and one or more coherency ordering agents (COAs), wherein each COA within the one or more COAs includes a directory snoop filter (DSF), and wherein each CCB within the one or more CCBs is communicatively coupled to each COA within the one or more COAs by a network-on-a-chip (NOC) interface; requesting, by a first CCB within the one or more CCBs, a cache line associated with a memory address, wherein the first CCB is not a sharer of the cache line; reading, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line; assigning, by the first COA, to the first CCB, an ownership of the cache line, wherein the assigning is recorded in the DSF; and forwarding the cache line, by the coherent LLC, to the first CCB.

The system 1400 can include a computer system for sharing data comprising: a memory which stores instructions; and one or more processors coupled to the memory, wherein the one or more processors, when executing the instructions which are stored, are configured to: access a system-on-a-chip (SoC), wherein the SoC includes one or more cache coherency blocks (CCBs) and one or more coherency ordering agents (COAs), wherein each COA within the one or more COAs includes a directory snoop filter (DSF), and wherein each CCB within the one or more CCBs is communicatively coupled to each COA within the one or more COAs by a network-on-a-chip (NOC) interface; request, by a first CCB within the one or more CCBs, a cache line associated with a memory address, wherein the first CCB is not a sharer of the cache line; read, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line; assign, by the first COA, to the first CCB, an ownership of the cache line, wherein the assigning is recorded in the DSF; and forward the cache line, by the coherent LLC, to the first CCB.

As can now be appreciated, disclosed embodiments provide techniques for direct data transfer with cache line owner assignment. In cases where a CCB requests ownership for a cache line that is currently unowned, and currently not shared by the requesting CCB, disclosed embodiments streamline the ownership process by enabling direct ownership granting, and transfer of the requested cache line in an efficient process that avoids the need for granting intermediate (temporary) ownership of a current sharer, to enable transferring ownership to the requesting CCB. In this way, disclosed embodiments improve performance of M×N mesh systems while maintaining proper cache coherency.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for sharing data comprising:
accessing a system-on-a-chip (SoC), wherein the SoC includes one or more cache coherency blocks (CCBs) and one or more coherency ordering agents (COAs), wherein each COA within the one or more COAs includes a directory snoop filter (DSF), and wherein each CCB within the one or more CCBs is communicatively coupled to each COA within the one or more COAs by a network-on-a-chip (NOC) interface;
requesting, by a first CCB within the one or more CCBs, a cache line associated with a memory address, wherein the first CCB is not a sharer of the cache line;
reading, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line;
assigning, by the first COA, to the first CCB, an ownership of the cache line, wherein the assigning is recorded in the DSF; and
forwarding the cache line, by the coherent LLC, to the first CCB.

2. The method of claim 1 wherein the cache line was previously evicted from a previous CCB owner.

3. The method of claim 1 wherein the NOC interface includes an M×N mesh topology.

4. The method of claim 3 wherein the Mx N mesh topology includes a coherent tile at each point of the M×N mesh topology.

5. The method of claim 4 wherein the first COA is located on a different coherent tile than the first CCB.

6. The method of claim 3 wherein the requesting comprises a request to own the cache line associated with the memory address.

7. The method of claim 6 wherein the forwarding includes sending, by the first COA, an invalidating snoop to the one or more CCB sharers of the cache line.

8. The method of claim 7 wherein the one or more CCB sharers of the cache line are indicated by a presence vector within the DSF.

9. The method of claim 8 further comprising back invalidating, by each CCB sharer within the one or more CCB sharers, a local cache line within a coherent cache which contains a copy of the data associated with the memory address.

10. The method of claim 9 wherein the sending the invalidating snoop is based on a local snoop vector.

11. The method of claim 10 wherein the local snoop vector enables communication between coherent tiles in the M×N mesh topology.

12. The method of claim 11 further comprising generating a snoop vector.

13. The method of claim 12 wherein the snoop vector includes the one or more CCB sharers of the cache line.

14. The method of claim 13 further comprising creating a directional snoop vector (DSV).

15. The method of claim 14 wherein the creating includes logically combining the snoop vector with the local snoop vector.

16. The method of claim 15 wherein the creating includes sending the DSV in a cardinal direction within the M×N mesh topology.

17. The method of claim 1 wherein the requesting includes determining, by the first CCB, to access the first COA, wherein the determining is based on the memory address.

18. The method of claim 1 wherein the DSF includes sharing and owner information for each shared cache line within a hierarchical coherent cache coupled to each CCB in the one or more CCBs.

19. The method of claim 1 wherein the first COA manages coherency between the one or more CCBs and other coherent caches within the SoC.

20. The method of claim 1 wherein the first CCB manages coherency between one or more processor cores on a multicore processor.

21. A computer program product embodied in a non-transitory computer readable medium for sharing data, the computer program product comprising code which causes one or more processors to generate semiconductor logic for:
accessing a system-on-a-chip (SoC), wherein the SoC includes one or more cache coherency blocks (CCBs) and one or more coherency ordering agents (COAs), wherein each COA within the one or more COAs includes a directory snoop filter (DSF), and wherein each CCB within the one or more CCBs is communicatively coupled to each COA within the one or more COAs by a network-on-a-chip (NOC) interface;
requesting, by a first CCB within the one or more CCBs, a cache line associated with a memory address, wherein the first CCB is not a sharer of the cache line;
reading, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line;
assigning, by the first COA, to the first CCB, an ownership of the cache line, wherein the assigning is recorded in the DSF; and
forwarding the cache line, by the coherent LLC, to the first CCB.

22. A computer system for sharing data comprising:
a memory which stores instructions; and
one or more processors coupled to the memory, wherein the one or more processors, when executing the instructions which are stored, are configured to:
access a system-on-a-chip (SoC), wherein the SoC includes one or more cache coherency blocks (CCBs) and one or more coherency ordering agents (COAs), wherein each COA within the one or more COAs includes a directory snoop filter (DSF), and wherein each CCB within the one or more CCBs is communicatively coupled to each COA within the one or more COAs by a network-on-a-chip (NOC) interface;
request, by a first CCB within the one or more CCBs, a cache line associated with a memory address, wherein the first CCB is not a sharer of the cache line;
read, within a first COA, a directory snoop filter (DSF), wherein the reading reveals one or more CCB sharers of the cache line, wherein the reading indicates that there is no CCB owner of the cache line, and wherein the first COA includes a coherent last level cache (LLC) that contains a valid copy of the cache line;
assign, by the first COA, to the first CCB, an ownership of the cache line, wherein the assigning is recorded in the DSF; and
forward the cache line, by the coherent LLC, to the first CCB.
